(19) United States
(12) Patent Application Publication
(10) Pub. No.: US 2026/0046615 A1
(43) Pub. Date: Feb. 12, 2026

(54) SYSTEM AND METHOD FOR GENERATING AND USING NETWORK SLICE-SPECIFIC KEYS

(71) Applicant: Verizon Patent and Licensing Inc., Basking Ridge, NJ (US)

(72) Inventors: Vinod Kumar Choyi, Conshohocken, PA (US); Yousif Targali, Sammamish, WA (US); Sudhakar Reddy Patil, Flower Mound, TX (US); Shanthala Kuravangi-Thammaiah, Keller, TX (US)

(21) Appl. No.: 18/798,055

(22) Filed: Aug. 8, 2024

(51) Int. Cl. H04W 12/04; H04W 60/00

(52) U.S. Cl. CPC H04W 12/04; H04W 60/00

(57) ABSTRACT

A device may comprise a processor. The processor may be configured to: receive, from a User Equipment device (UE), a registration request; receive, from a network function, an indication that the first network device is to use a first set of security keys for communications between the UE and a first network slice and a second set of security keys for communications between the UE and a second network slice; generate the first set of security keys and the second set of security keys in response to receiving the indication; use the first set of security keys for securing first communications between the UE and the first network slice; and use the second set of security keys for securing second communications between the UE and the second network slice.

### BACKGROUND INFORMATION

Fifth Generation (5G) networks offer many technological features unavailable in predecessor networks. For example, through use of network slicing, 5G networks may provide application and subscriber-specific Quality-of-Service (QoS) services for a variety of applications. Other benefits of network slicing may include improved network resource utilization, faster rollout times for new services without significant modifications to the existing network infrastructure, and increased security.

### BRIEF DESCRIPTION OF THE DRAWINGS

FIG. 1 illustrates concepts described herein.

FIG. 2 illustrates an exemplary network environment in which systems and methods described herein may be implemented.

FIG. 3 depicts exemplary Fifth Generation (5G) core network components, according to an implementation.

FIG. 4 depicts a hierarchy of example keys that are generated by various network components, according to an implementation.

FIG. 5 illustrates example use of keys in communications between a User Equipment device (UE) and network components, according to an implementation.

FIG. 6 is a flow diagram of an exemplary process that is associated with using network slice-specific keys.

FIG. 7 illustrates example messages that are exchanged between network components for using network slice-specific keys, according to an implementation.

FIG. 8 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID) or some other identifier.

Systems and methods described herein relate to using network slice-specific keys in 5G or other advanced networks. After a User Equipment device (UE) sends a request for registration to a provider network, the UE (e.g., a smartphone) and the provider network may engage in 5G Authentication and Key Agreement (5G AKA) or Extensible Authentication Protocol-Authentication and Key Agreement (EAP-AKA′). Thereafter, the UE and the provider network may each generate a set of security keys. The UE and the provider network may use the keys to secure their respective communication protocol stacks and to ensure that all communications are with an authorized party/entity.

Typically, when a UE connects to one or more network slices (e.g., logical networks) in the provider network, the UE may use the same set of keys to communicate with each of the network slices. For example, the same set of keys may be used for Radio Resource Control (RRC) signaling, User Plane (UP) data transport, and Non-Access Stratum (NAS) signaling. However, this arrangement may not be ideal for situations in which server applications (or simply applications) on different network slices have varying levels of security requirements or postures or requiring varying security assurances. For example, a cloud gaming application hosted on a network slice may have a lower level of security than that for an enterprise application hosted on another network slice. Because the set of keys are the same for different network slices, an application running on one network slice has the potential to tamper with RRC and NAS messages that affect communications between the UE and an application hosted on another network slice. This has the potential to lead to Denial-of-Service (DoS) types of attacks or degradation of application service-type of attacks. Furthermore, an application hosted on one network slice has the potential to eavesdrop on user plane traffic between the UE and another application on a different network slice and initiate Information Disclosure-types of attacks. The systems and methods described herein address these issues, with a UE and the provider network using different sets of security keys for UE communications with each of the network slices.

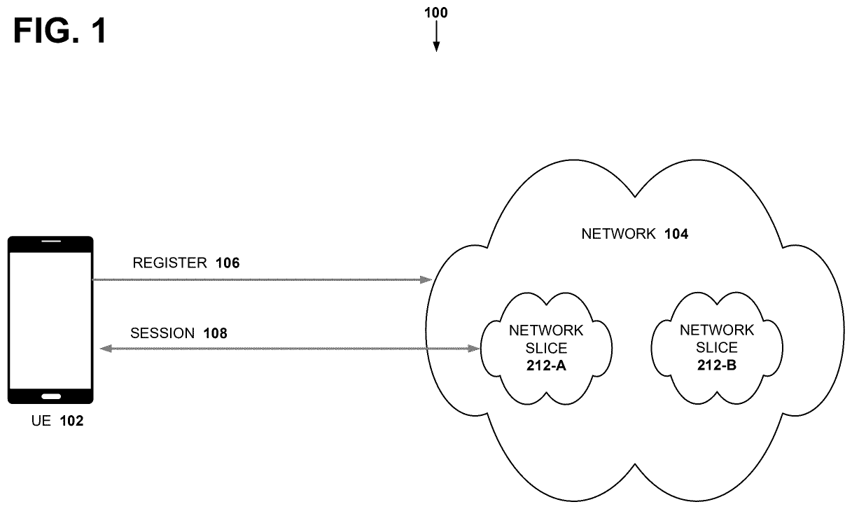

FIG. 1 illustrates concepts described herein. As shown, a use-case scenario 100 includes a UE 102 and a provider network 104 (or simply network 104), which in turn includes network slices 212-A and 212-B. During UE registration 106 at network 104, network 104 determines whether network 104 is to use the same set of security keys or different sets of security keys for UE 102's communications with network slices 212-A and 212-B. When network 104 determines that, for UE 102, using network slice-specific security keys (SSKs) for network slices 212-A and 212-B is warranted, network 104 may notify UE 102 of the result of its determination (e.g., an indication that UE 102 and network 104 are to use SSKs). Thereafter, both UE 102 and network 104 each generate network slice-specific keys. When UE 102 establishes a session 108 with network slice 212-A, UE 102 may use a set of security keys specific to network slice 212-A to communicate with network slice 212-A; and when UE 102 establishes a session (not shown) with network slice 212-B, UE 102 may use a different set of security keys specific to network slice 212-B to communicate with network slice 212-B.

In scenario 100, had network 104 determined that using network slice-specific keys for UE 102 is not warranted, network 104 would have notified UE 102 that the same set of keys are to be used for communications with network slices 212-A and 212-B. Both UE 102 and network 104 each would then generate and use a single set of security keys for communications with network slices 212-A and 212-B. Although only two network slices 212-A and 212-B are depicted in FIG. 1, in some implementations, UE 102 may communicate via additional network slices in provider network 104, with UE 102 and network 104 generating and using more than two sets of network slice-specific keys.

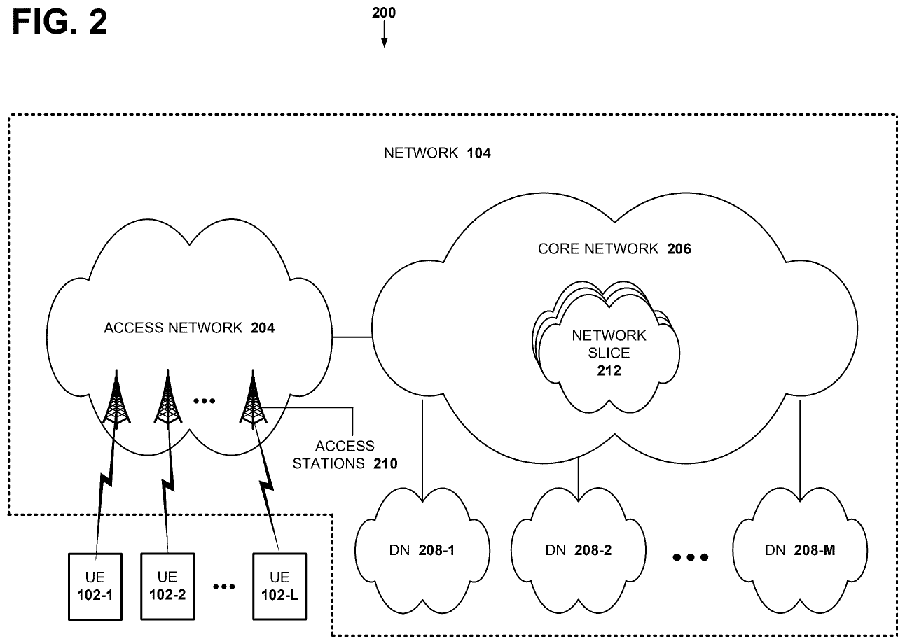

FIG. 2 illustrates an exemplary network environment 200 in which systems and methods described herein may be implemented. As shown, network environment 200 may include UEs 102-1 through 102-L (collectively referred to as UEs 102 and generically referred to as UE 102), access network 204, core network 206, and data networks (DNs) 208-1 through 208-M (collectively referred to as data networks 208 and generically as data network 208). Access network 204, core network 206, and data networks 208 may be part of provider network 104.

UEs 102 may include a wireless communication device capable of Fourth Generation (4G) (e.g., Long-Term Evolution (LTE)) communication, 5G New Radio (NR) communication, and/or other wireless communication (e.g., Sixth Generation (6G) communication). Examples of UE 102 include: a Fixed Wireless Access (FWA) device; a Customer Premises Equipment (CPE) device with 4G and 5G capabilities; a smart phone; a tablet device; a wearable computer device (e.g., a smart watch); a global positioning system (GPS) device; a laptop computer; a media playing device; a portable gaming system; an autonomous vehicle navigation system; a sensor; and an Internet-of-Things (IoT) device. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-IoT devices.

UEs 102 may be capable of storing multiple master keys for different network slices. For example, UE 102 may include a master key in its embedded subscriber identity module (eSIM) associated with provider network 104. After its registration at network 104 and before it establishes any session with a network slice in provider network 104, UE 102 may receive an indication of a security mode for establishing and conducting sessions with the network slices. For example, UE 102 may be notified by network 104 to use a single set of security keys or SSKs. Upon receipt of the notification, UE 102 may generate an appropriate hierarchy of security keys for establishing and conducting its sessions with slices in network 104.

Access network 204 may enable UE 102 to connect to core network 206 by establishing and managing over-the-air channels with UE 102 and backhaul channels with core network 206. These channels carry information between UE 102 and core network 206. Access network 204 may comprise LTE, 5G NR, or other advanced radio access networks (RANs), featuring components such as central units (CUs), distributed units (DUs), radio units (RUs), and/or base stations (e.g., Next Generation Base Station B (gNodeB or gNB), evolved Node B (eNB), etc.). These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., eNB, gNB, etc.) that comprises one or more radio frequency (RF) transceivers. In some embodiments, access station 210 may be part of an evolved Universal Mobile Telecommunications Service (UMTS) Terrestrial Radio Access Network (eUTRAN).

In some use-cases, when UE 102 registers with network 104, network 104 may notify access station 210 of a particular security mode for signaling/communications with UE 102. For example, in one embodiment, network 104 may notify access station 210 to use a single key or SSKs for UE communications with network slices. In the latter case, access station 210 may receive, for network slices with which UE 102 may communicate, a slice-specific key (K_{gNB}) and generate a corresponding set of security keys. When the SSK mode is in effect, access station 210 may use each slice-specific key to generate corresponding keys for RRC signaling and/or user plane data transport between UE 102 and access station 210.

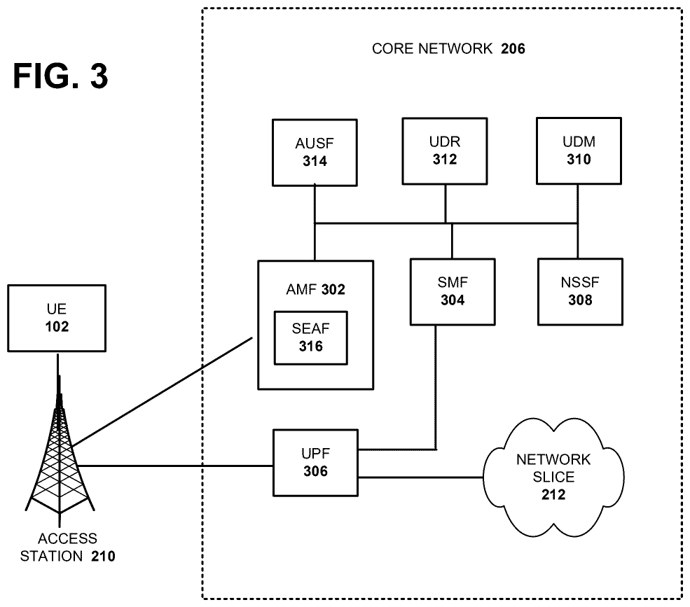

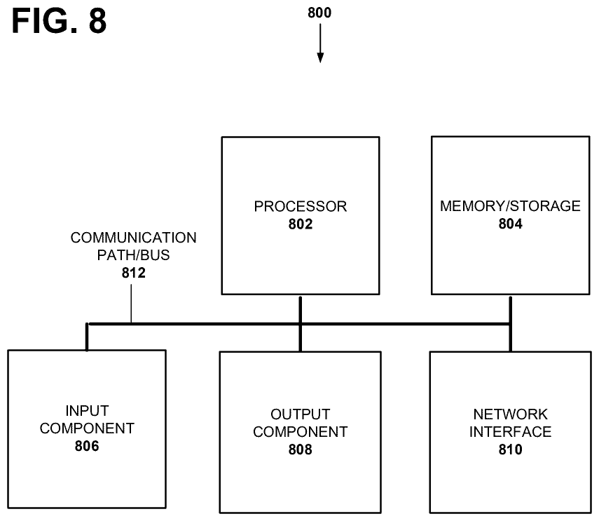

Core network 206 may manage communication sessions for subscribers connecting via access network 204. For instance, core network 206 may facilitate the establishment of Internet Protocol (IP) connections between UEs 102 and data networks 208. The components within core network 206 can be either dedicated hardware elements or virtualized functions operating atop a shared physical infrastructure which employs Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 800, as described below with reference to FIG. 8, within a cloud computing center associated with core network 206. Moreover, core network 206 may encompass 5G core network components, 4G core network components, or other types of components. Further elaboration on some of these components is provided below with reference to FIG. 3.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular Quality-of-Service (QoS) Class Identifier (QCI), a type of service, a 5G QoS Identifier (5QI), security services, security assurance levels (e.g. cryptographic schemes, key length etc.) and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAIs that identify the network slices 212.

When configured to support the use of SSKs for UE 102 communication with network slices 212, core network 206 may determine, for each UE 102 registering at network 104, whether UE 102 is to use SSKs for its communication with network slices 212 and notify UE 102 of its determination. Furthermore, core network 206 may generate, for each of the network slices 212 with which UE 102 may communicate, a set of SSKs, including Non-Access Stratum (NAS) keys for NAS signaling and a K_{gNB} for Access stratum (AS). Core network 206 may pass K_{gNB} to access station 210 and use the NAS keys for NAS communication with UE 102, per network slice 212.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. In a 5G network, data network 208 that is implemented on network slice 312 may be associated with a DNN (e.g., an Internet Protocol Multimedia Subsystem (IMS) data network 208 or an Internet data network 208 implemented on network slice 212). Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may render services to other applications running on UEs 102 and may establish communication sessions with UEs 102 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts exemplary 5G core network components 302-314 in core network 206 according to an implementation. One or more of 5G core network components 302-314, in conjunction with other network components, may implement a network-side of a system for using SSKs. As shown, core network 206 may include Access and Mobility Management Function (AMF) 302, a Session Management Function (SMF) 304, a User Plane Function (UPF) 306, a Network Slice Selection Function (NSSF) 308, a Unified Data Management function (UDM) 310, a Unified Data Repository (UDR) 312, and an Authentication Server Function (AUSF) 314. Although core network 206 is depicted as including network components 302-314 in FIG. 3, in other implementations, core network 206 may include additional, fewer, and/or different 5G core network components than those illustrated in FIG. 3. For example, core network 206 may further include a Charging Function (CHF), a Policy Control Function (PCF) and other network functions (NFs). In addition, depending on the implementation, core network 206 may or may not include network slice 212.

AMF 302 may perform registration management, connection management, reachability management, mobility management, lawful intercepts, Short Message Service (SMS) transport between UE 102 and a Short Message Service Function (SMSF), session management messages transport between UE 102 and SMF 304, access authentication and authorization, location services management, functionality to support Non-Third Generation Partnership Program (3GPP) access networks, and/or other types of management processes. As further shown, AMF 302 may include Security Anchor Function (SEAF) 316. AMF 302/SEAF 316 in combination may support the use of SSKs. During registration of UE 102, the subscription information, which is associated with UE 102 and which AMF 302 obtains from UDM 310, may indicate whether network 104 is to use SSKs. If the subscription information indicates that network 104 is to use SSKs, AMF 302/SEAF 316 may use a key K_{SEAF} that SEAF 316 receives from AUSF 314 to generate unique keys K_{AMF1}, K_{AMF2} . . . corresponding to the network slices 212 with which UE 102 may establish and conduct sessions. Next, AMF 302 may use keys K_{AMF1}, K_{AMF2} . . . to generate, for the network slices, a pair of NAS keys K_{NAS-INT} and K_{NAS-ENC} and an access station key K_{gNB}, where K_{NAS-INT}, K_{NAS-ENC}, and K_{gNB} denote a key for checking NAS message integrity, a key for decrypting/encrypting NAS messages, and a key that AMF 302 passes to access station 210. That is, AMF 302 may generate key vectors <K_{NAS-INT1}, K_{NAS-ENC1}, K_{gNB1}>, <K_{NAS-INT2}, K_{NAS-ENC2}, K_{gNB2}> . . . which correspond to K_{AMF1}, K_{AMF2} . . . and the network slices 212. During SSK communications, AMF 302 may use one or more of <K_{NAS-INT1}, K_{NAS-ENC1}>, <K_{NAS-INT2}, K_{NAS-ENC2}> . . . for communications that involve UE 102 and network slices 212.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward a PCF (not shown), perform lawful intercepts, charge data collection, support charging interfaces, control and coordinate charging data collection, terminate session management parts of NAS messages, perform downlink data notification, manage roaming functionality, and/or perform other types of control plane processes for managing user plane data.

UPF 306 may maintain an anchor point for intra/inter-Radio Access Technology (RAT) mobility, maintain an external Protocol Data Unit (PDU) session point of interconnect to a particular data network (e.g., data network 208 or a network slice 212), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., access station 210), and/or perform other types of user plane processes.

NSSF 308 may select one or more networks based on subscription information, network policies, and/or the requirements of the requested service and provide an identifier for the selected network slice. In selecting the network slices, NSSF 308 may apply particular network selection policies (e.g., policies for optimizing network resources) provided by a network service provider or operator or the PCF.

UDM 310 may maintain subscription information for UEs 102, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store the information that it manages in UDR 312. The subscription information may include information that is associated with the subscribers of UEs 102, such as an indication of whether UE 102 is to use SSKs for its communications with network slices 212 and which of the network slices 212 with which UE 102 is to communicate is eligible for SSK. The subscription information may be made available to other network components or network functions (NFs) via UDM 310. Thus, when a network function requests subscription information, UDM 310 may first obtain the information from UDR 312 and provide the obtained information. UDR 312 may also include policy data and application data. The policy data may include policy rules and parameters associated with the policy rules. The application data may comprise information and/or data collected by applications.

During authentication of UE 102, UDM 310/UDR 312 may fetch or obtain authentication information for AUSF 314. In addition, UDM 310/UDR 312 may obtain (e.g., retrieve) a master key or a primary key K_{P} for UE 102. Furthermore, UDM 310 may derive a key K_{AUSF} based on K_{P} and provide K_{AUSF} to AUSF 314. In addition, during registration of UE 102, UDM 310 may provide an indication of whether UE 102 is to use SSKs to AMF 302.

AUSF 314 may receive a request to perform authentication from AMF 302, perform the authentication (e.g., using data from UDM 310), and provide an authentication vector to AMF 302. The authentication vector may include, for example, a random number, an authentication token and an expected UE 102 response. AUSF 314 may also receive key K_{AUSF} that UDM 310 generates and use K_{AUSF} to derive another key K_{SEAF}. AUSF 314 may provide K_{SEAF} to SEAF 316, which may use K_{SEAF} to generate SSKs for AMF 302 for each of network slices 212 with which UE 102 may communicate (i.e., K_{AMF1}, K_{AMF2}, ...).

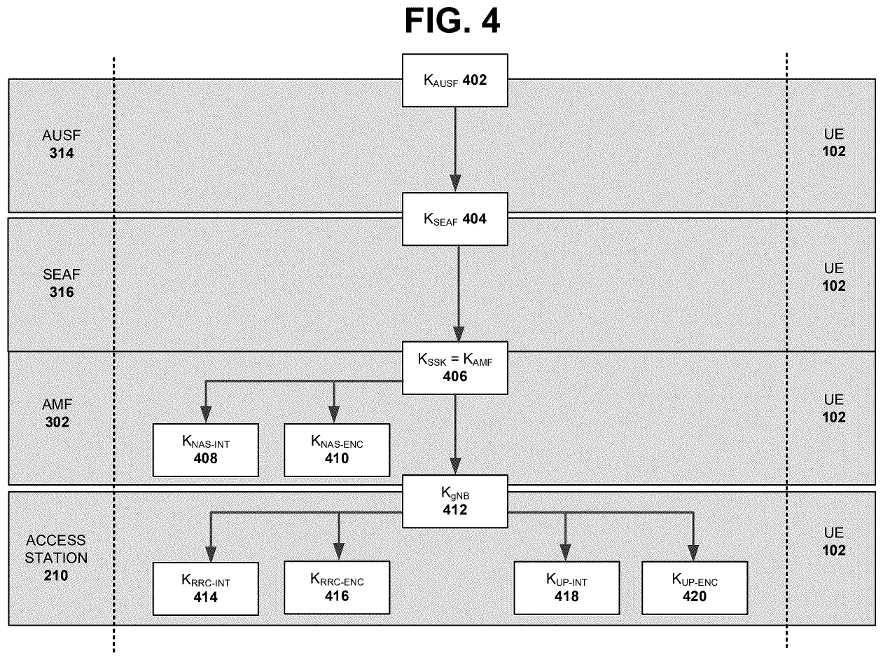

FIG. 4 depicts a hierarchy of example keys that are generated by various network components and for using SSKs, according to an implementation. As shown, on the network side, AUSF 314 uses K_{AUSF} 402, which AUSF 314 receives from UDM 310, to calculate K_{SEAF} 404. AUSF 314 may then pass K_{SEAF} 404 to SEAF 316. Assuming that the network, based on home network or serving network policies, determines to use SSKs, SEAF 316 may generate K_{AMF} 406 for each of network slice 212 to which UE 102 may establish sessions. That is, for Y number (e.g., whole number) of network slices, SEAF 316 may generate keys K_{AMF1}, K_{AMF2} . . . K_{AMFY} and pass the keys to AMF 302. In generating each K_{AMF}s 406 for network slice 212, SEAF 316 may use an identifier for the network slice 212, for example, as a seed or one of inputs to a key-generating function. This ensures that each K_{AMF1} 406 is different from K_{AMF2} 406 for another network slice 212 for UE 102.

When AMF 302 receives K_{AMF} (e.g., K_{AMF1}, K_{AMF2} . . . where each of K_{AMF1}, K_{AMF2} . . . is unique and corresponds to each of the network slices for UE 102), AMF 302 may use keys K_{AMF} to generate, for the network slices, a pair of NAS keys K_{NAS-INT} 408 and K_{NAS-ENC} 410 and an access station key K_{gNB} 412 (g.e., K_{NAS-INT1}, K_{NAS-ENC1}, and K_{gNB1}; K_{NAS-INT2}, K_{NAS-ENC2}, and K_{gNB2} . . . etc.).

AMF 302 may pass K_{gNB} 412 (unique to a particular network slice 212) to access station 210 through which AMF 302 signals UE 102. When access station 210 receives K_{gNB} 412 that is unique for each of the network slices 212, access station 210 may generate two pairs of keys (K_{RRC-INT}, K_{RRC-ENC}) and (K_{UP-INT}, K_{UP-ENC}) for the network slice, where K_{RRC-INT} 414 denotes a key for checking RRC message integrity; K_{RRC-ENC} 416 denotes a key for encrypting/decrypting RRC messages; K_{UP-INT} 418 denotes a key for checking the integrity of user plane traffic; and K_{UP-ENC} 420 denotes a key for encrypting/decrypting user plane traffic. Access station 210 may generate these keys for each of network slices 212 (or for each of the K_{AMF}s).

On the UE 102 side, UE 102 may generate each of keys 402-420. Network 104 may provide UE 102 with an indication that UE 102 and network 104 are to use SSKs and a seed that UE 102 may use in generating one or more of keys 402-420. To generate K_{AMF}s, UE 102 may use identifiers (IDs) of network slices 212 that UE 102 may access (e.g., S-NSSAIs).

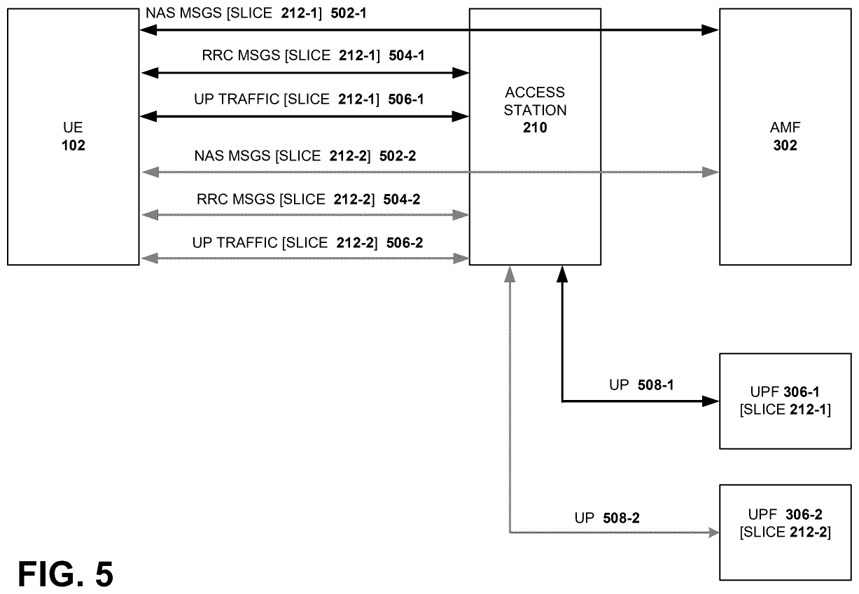

FIG. 5 illustrates example use of network SSKs 408, 410, and 414-420 for communications between UE 102 and network components, according to an implementation. As shown, for network slice 212-1, UE 102 may exchange NAS messages 502-1 with AMF 302; exchange RRC messages 504-1 with access station 210; and receive or send user plane (UP) traffic 506-1 from/to access station 210. For exchanging NAS messages 502-1, UE 102 and AMF 302 may use K_{NAS-INT1} 408-1 and K_{NAS-ENC1} 410-1; for exchanging RRC messages 504-1, UE 102 and access station 210 may use K_{RRC-INT1} 414-1 and K_{RRC-ENC1} 416-1; and for sending or receiving user plane traffic, UE 102 and access station 210 may use K_{UP-INT1} 418-1 and K_{UP-ENC1} 420-1.

For network slice 212-2, UE 102 may exchange NAS messages 502-2 with AMF 302; exchange RRC messages 504-2 with access station 210; and receive or send UP traffic 506-2 from/to access station 210. For exchanging NAS messages 502-2, UE 102 and AMF 302 may use K_{NAS-INT2} 408-2 and K_{NAS-ENC2} 410-2; for exchanging RRC messages 504-2, UE 102 and access station 210 may use K_{RRC-INT2} 414-2 and K_{RRC-ENC2} 416-2; and for sending or receiving user plane traffic, UE 102 and access station 210 may use K_{UP-INT2} 418-2 and K_{UP-ENC2} 420-2.

As further shown in FIG. 5, at access station 210, user plane traffic for network slice 212-1 is forwarded to or received from UPF 306-1 (see user plane traffic 508-1) that serves as a gateway to network slice 212-1. Similarly, user plane traffic for network slice 212-2 is forwarded to or received from UPF 306-2 (see user plane traffic 508-2), which serves as a gateway to network slice 212-2.

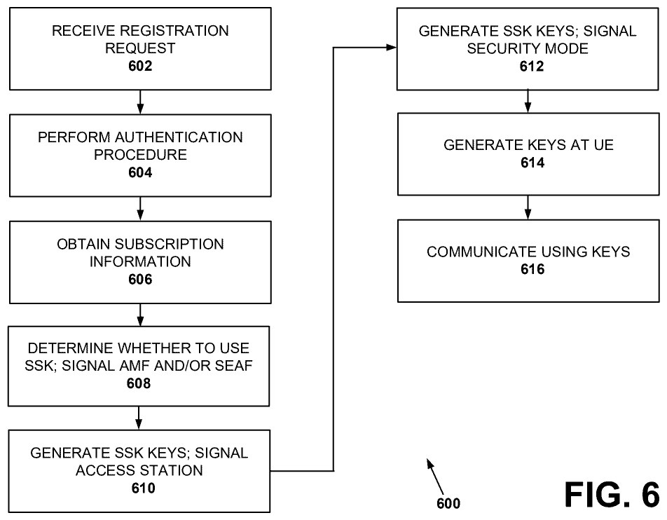

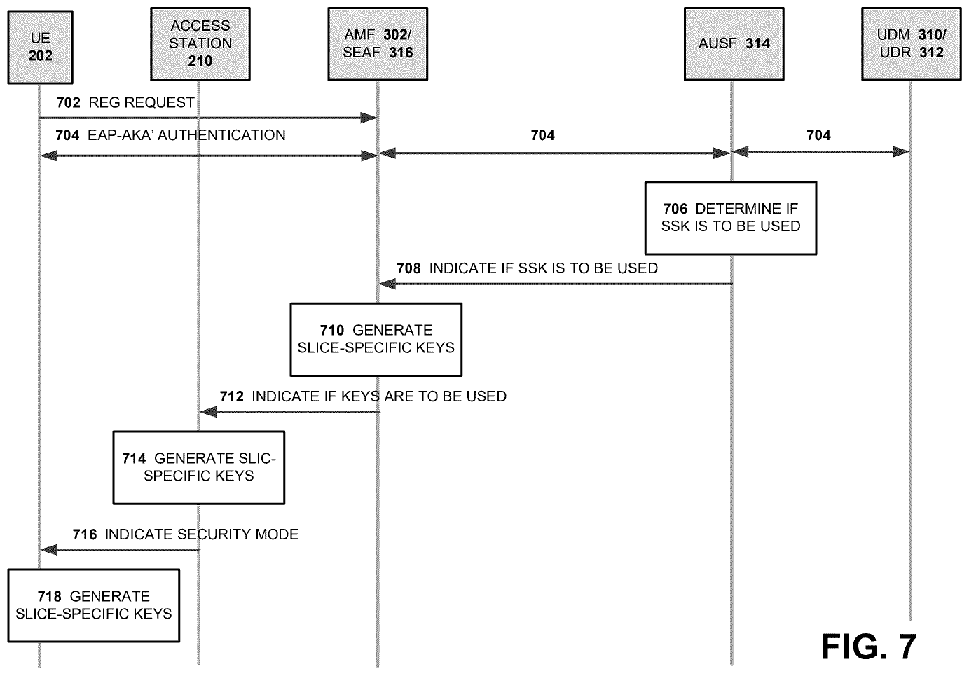

FIG. 6 is a flow diagram of an exemplary process 600 that is associated with using SSKs. FIG. 7 illustrates example messages that are exchanged between network components during process 600. FIG. 7 is described below together with process 600. Process 600 may be performed by various components of network 104, including those depicted in FIG. 1-5. Each block and/or arrow in FIGS. 6 and 7 is not intended to signify every action performed by the network components or every message sent by the components. For example, FIGS. 6 and 7 may not show some actions and/or messages transmitted as replies to messages.

As shown, process 600 may include AMF 302 receiving registration request from UE 102 (block 602; arrow 702). As part of the registration process, AMF 302, UE 102, and other network components may perform an authentication procedure (block 604), which involves exchange of 5G-AKA or EAP-AKA′ messages between UE 102, AMF 302/SEAF 316, AUSF 314, and/or UDM 310/UDR 312 (arrow 704). For example, AMF 302 may request AUSF 314 to perform an authentication of UE 102, passing UE credentials to AUSF 314.

Process 600 may further include AUSF 306 accessing subscription information from UDM 310 (block 606; arrow 704). For example, in response to the authentication request from AMF 302, AUSF 314 may obtain subscription information and key-related information via UDM 310. During this process, UDM 310 may generate and pass K_{AUSF} 402 to AUSF 314. Furthermore, AUSF 314 may determine whether to use SSKs for UE communication with network slices 212 (block 608; block 706). The determination to perform SSK may be based on subscriber profile (which is associated with a mobile subscriber or a user of U #102) that is stored in the UDR 312 or based on a request received from the AMF as part of the 5G-AKA or EAP-AKA′ authentication (block 604; arrow 704). Assuming that AUSF 314 determines that SSKs are to be used for UE 102, AUSF 314 may signal AMF 302 and/or SEAF 316 with the result of its determination (block 608; arrow 708). In addition, AUSF 314 may generate K_{SEAF} 404 and pass K_{SEAF} to AMF 302/SEAF 316.

Process 600 may further include AMF 302/SEAF 316 generating its set of keys for each of the network slices 212 with which UE 102 may communicate (block 610; block 710). For example, as described above, AMF 302/SEAF 316 may use K_{SEAF} 404 and network slice-related information (e.g., S-NSSAIs) to generate K_{AMF} 406 for each of the network slices 212. Next, for each of network slices 212, AMF 302 may use key K_{AMF} 406 to generate a pair of NAS keys K_{NAS-INT} 408 and K_{NAS-ENC} 410 and an access station key K_{gNB} 412. Thereafter, AMF 302 may signal access station 210 whether SSKs are to be used (block 610; arrow 712), passing K_{gNB} 412 to access station 210.

Process 600 may further include access station 210 generating SSKs (block 612; block 714). When access station 210 receives K_{gNB} 412 for each of the network slices 212, access station 210 may generate two pairs of keys (K_{RRC-INT}, 414, K_{RRC-ENC} 416) and (K_{UP-INT} 418, K_{UP-ENC} 420). Access station 210 may generate these keys for each of network slices 212. Next, access station 210 may notify UE 102 of its security mode (e.g., indicate whether UE 102 and network 104 are to use SSKs) (block 612; arrow 716). When UE 102 receives the notification, UE 102 may generate an appropriate hierarchy of SSKs (block 614; block 718). For example, UE 102 may generate each of keys 402-420. To generate K_{AMF}s, UE 102 may use identifiers (IDs) of network slices 212 that UE 102 may access (e.g., S-NSSAIs).

Process 600 may include UE 102 and network 104 using one or more of generated keys 402-420 to communicate. For example, as discussed above with reference to FIG. 5, UE 102 and access station 210 may use K_{RRC-INT} 414 to check the integrity of RRC messages between UE 102 and access station 210; use K_{RRC-ENC} 416 to encrypt/decrypt RRC messages between them; use K_{UP-INT} 418 to check the integrity of UP traffic between UE 102 and access station 210; and use K_{UP-ENC} 420 to encrypt/decrypt the UP traffic between UE 102 and access station 210. For NAS messages between UE 102 and AMF 302, UE 102 and AMF 302 may use K_{NAS-INT} 408 and KNAS-ENC 410 for NAS message integrity check and NAS message encryption and decryption. The UP data at access station 210 may be received from/forwarded to a particular UPF 306 that serves as a gateway to a particular network slice 212 with which UE 102 has established a Protocol Data Unit (PDU) session. Access station 210 and UPF 306 may establish, for example, a General Packet Radio Service (GPRS) Tunneling Protocol (GTP)-U tunnel between access station 210 and UPF 306 to carry the user traffic between access station 210 and UPF 306. SMF 304 may control the GTP-U between access station 210 and UPF 306 via a GTP-Control Plane 9GTP-C).

FIG. 8 depicts exemplary components of a network device 800. Network device 800 may correspond to or be included in any of the devices and/or components illustrated in FIGS. 1-5 and 7 (e.g., network 104, UE 102, access network 204, core network 206, data network 208, network slices 212, access station 210, and core network components 302-316). In some implementations, network devices 800 may be part of a hardware network layer on top of which other network layers and NFs may be implemented.

As shown, network device 800 may include a processor 802, memory/storage 804, input component 806, output component 808, network interface 810, and communication path 812. In different implementations, network device 800 may include additional, fewer, different, or different arrangement of components than the ones illustrated in FIG. 8. For example, network device 800 may include line cards, switch fabrics, modems, etc.

Processor 802 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 800 and/or executing programs/instructions.

Memory/storage 804 may include static memory, such as read only memory (ROM), and/or dynamic memory, such as random access memory (RAM), or onboard cache, for storing data and machine-readable instructions (e.g., programs, scripts, etc.). Memory/storage 804 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 804 may be external to and/or removable from network device 800. Memory/storage 804 may include, for example, a Universal Serial Bus (USB) memory stick, a dongle, a hard disk, off-line storage, a Blu-Ray® disk (BD), etc. Memory/storage 804 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 806 and output component 808 may provide input and output from/to a user to/from network device 800. Input/output components 806 and 808 may include a display screen, a keyboard, a mouse, a speaker, a microphone, a camera, a DVD reader, USB lines, and/or other types of components for obtaining, from physical events or phenomena, to and/or from signals that pertain to network device 800.

Network interface 810 may include a transceiver (e.g., a transmitter and a receiver) for network device 61o to communicate with other devices and/or systems. For example, via network interface 810, network device 800 may communicate over a network, such as the Internet, an intranet, cellular, a terrestrial wireless network (e.g., a WLAN, WIFI, WIMAX, etc.), a satellite-based network, optical network, etc. Network interface 810 may include a modem, an Ethernet interface to a LAN, and/or an interface/connection for connecting network device 800 to other devices (e.g., a Bluetooth interface).

Communication path or bus 812 may provide an interface through which components of network device 800 can communicate with one another.

Network device 800 may perform the operations described herein in response to processor 802 executing software instructions stored in a non-transient computer-readable medium, such as memory/storage 804. The software instructions may be read into memory/storage 804 from another computer-readable medium or from another device via network interface 61o. The software instructions stored in memory/storage 804, when executed by processor 802, may cause processor 802 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 6 and 7. the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

As used above, the term “session” may refer to a series of communications, of a limited duration, between two endpoints (e.g., two applications, two devices, etc.). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term “PDU session” or packet data network “(PDN) session” may refer to communications between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDN session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising:
a first network device configured to:
receive, from a User Equipment device (UE), a registration request;
receive, from a network function, an indication that the first network device is to use a first set of security keys for communications between the UE and a first network slice and a second set of security keys for communications between the UE and a second network slice;
generate the first set of security keys and the second set of security keys in response to receiving the indication;
use the first set of security keys for first communications between the UE and the first network slice; and
use the second set of security keys for second communications between the UE and the second network slice.

2. The system of claim 1, wherein the first network device comprises an Access and Mobility Management Function (AMF) and a Security Anchor Function (SEAF).

3. The system of claim 1, wherein when the first network device receives the indication, the first network device is configured to:
receive the indication and a security anchor function (SEAF) key from an Authentication Server Function (AUSF).

4. The system of claim 1, further comprising an Authentication Server Function (AUSF), wherein the AUSF is configured to:
receive subscription information associated with the UE and security information from a Unified Data Management function (UDM);
determine, based on the subscription information, that the first network device is to use the first set of security keys for communications between the UE and the first network slice and use the second set of security keys for communications between the UE and the second network slice; and
send the indication to the first network device.

5. The system of claim 4, further comprising the UDM, wherein the security information includes an AUSF key and wherein the UDM is configured to:
generate the AUSF key based on a master key; and
send the AUSF key to the AUSF.

6. The system of claim 1, wherein when generating the first set of security keys, the first network device is configured to:
use a first Single-Network Slice Selection Assistance Information to generate the first set of security keys.

7. The system of claim 1, wherein when the first network device uses the first set of security keys for the first communications between the UE and the first network slice, the first network device is configured to:
use the first set of security keys for Non-Access Stratum (NAS) messages between the first network device and the UE.

8. The system of claim 7, wherein the first set of security keys includes:
a first NAS key for checking integrity of the NAS messages;
a second NAS key for encrypting or decrypting the NAS messages; and
a key that the first network device sends to an access station.

9. The system of claim 1, further comprising an access station, wherein the access station is configured to:
receive an access station key from the first network device; and
generate, based on the access station key, a third set of security keys for securing Radio Resource Control (RRC) messages between the UE and the access station.

10. The system of claim 9, wherein the first network device is further configured to:
send, to the UE, an indication that the UE is to use different keys to communicate via different network slices.

11. A method comprising:
receiving, from a User Equipment device (UE), a registration request;
receiving, from a network function, an indication that a first network device is to use a first set of security keys for communications between the UE and a first network slice and a second set of security keys for communications between the UE and a second network slice;
generating the first set of security keys and the second set of security keys in response to receiving the indication;
using the first set of security keys for first communications between the UE and the first network slice; and
using the second set of security keys for second communications between the UE and the second network slice.

12. The method of claim 11, wherein the first network device comprises an Access and Mobility Management Function (AMF) and a Security Anchor Function (SEAF).

13. The method of claim 11, wherein receiving the indication comprises:
receiving the indication and a security anchor function (SEAF) key from an Authentication Server Function (AUSF).

14. The method of claim 11, further comprising:
receiving subscription information associated with the UE and security information from a Unified Data Management function (UDM);
determining, based on the subscription information, that the first network device is to use the first set of security keys for communications between the UE and the first network slice and use the second set of security keys for communications between the UE and the second network slice; and
sending the indication to the first network device.

15. The method of claim 14, further comprising:
generating an Authentication Server Function (AUSF) key based on a master key; and
sending the AUSF key to an AUSF.

16. The method of claim 11, wherein generating the first set of security keys comprises:
using a first Single-Network Slice Selection Assistance Information to generate the first set of security keys.

17. The method of claim 11, wherein using the first set of security keys for securing the first communications between the UE and the first network slice comprises:
using the first set of security keys to secure Non-Access Stratum (NAS) messages between the first network device and the UE.

18. The method of claim 17, wherein the first set of security keys includes:
a first NAS key for checking integrity of the NAS messages;
a second NAS key for encrypting or decrypting the NAS messages; and
a key that the first network device sends to an access station.

19. The method of claim 11, further comprising:
receiving an access station key from the first network device; and
generating, based on the access station key, a third set of security keys for Radio Resource Control (RRC) messages between the UE and an access station.

20. A non-transitory computer-readable medium comprising processor-executable instructions, wherein when executed by a processor in a first network device, the processor-executable instructions cause the processor to:
receive, from a User Equipment device (UE), a registration request;
receive, from a network function, an indication that the first network device is to use a first set of security keys for communications between the UE and a first network slice and a second set of security keys for communications between the UE and a second network slice;
generate the first set of security keys and the second set of security keys in response to receiving the indication;
use the first set of security keys for first communications between the UE and the first network slice; and
use the second set of security keys for second communications between the UE and the second network slice.
